(19) United States
(12) Patent Application Publication
(10) Pub. No.: US 2011/0176336 A1
(43) Pub. Date: Jul. 21, 2011

(54) Isolated current regulated DC-DC converter

(76) Inventors: Da Feng Weng, Sunnyvale, CA (US); Qi Cui Wei, (US)

(21) Appl. No.: 12/799,389

(22) Filed: Apr. 26, 2010

(30) Foreign Application Priority Data
Jan. 19, 2010 (CN) 201010040043.4

(51) Int. Cl. H02M 3/335

(52) U.S. Cl. 363/21.04

(57) ABSTRACT

The isolated current regulated DC-DC converter is composed of the step down switch SA, free wheel diode DA, step down inductor L, switches S1 and S2, capacitor Cc to absorb the leakage energy of the switching transformer, output diodes D3 and D4, output filter capacitor C and the switching transformer T; one terminal of the step down inductor L is connected with the step down switch SA and free wheel diode DA, and other terminal of the step down inductor L is connected with one of primary windings of the switching transformer and switch S1 or S2; two primary windings of the switching transformer are respectively connected with switches S1 and S2 in series; two primary winding and switch S1 or S2 branches are paralleled and respectively connected with the free wheel diode DA and the step down inductor L; the free wheel diode DA is series with the step down switch SA and they connect with the input voltage Vin; the capacitor Cc to absorb the leakage energy of the switching transformer is respectively connected with switches S1 and S2; the full wave rectifier is composed of two secondary windings and output diodes D3, D4; the output capacitor C is paralleled with the output load. The converter has the same voltage and current stress and dynamic regulation as one of regular step down DC-DC converter. It also has function to isolate the input and the output with the switching transformer. In practical application, due to the freedom of the switching transformer's turns-ratio, it is possible to make the isolated current regulated DC-DC converter to operate in much better condition than one for the regular step down DC-DC converter and to have higher efficiency.

### TECHNICAL FIELD

Embodiments of the invention described herein relate generally to isolated DC-DC converter topology, and more particularly to high performance low cost isolated current regulated DC-DC converter.

### BACKGROUND OF THE INVENTION

In a lot of DC-DC converter application, due to application requirement, it needs to isolate the DC-DC converter's input and output. In general, it can be implemented with a switching transformer. In other application, due to higher voltage ratio of the input to output of the DC-DC converter application, in order to increase the efficiency of the DC-DC converter, in general, a suitable turns-ratio of the high switching frequency transformer is used to make the DC-DC converter operation in optimum and to increase the efficiency. In most of this kind low and middle power level application, flyback and forward DC-DC converters are the main power topology structures. With them, it is possible to build a system with less component account, but each component will surfer higher voltage and current stress.

In the flyback converter, it is only as the switching transformer's primary switch of the DC-DC converter turns off, the transformer of the converter will offer energy to the load. The components in both switching transformers' primary and secondary sides must surfer higher voltage and current stress. Due to discontinuous energy transfer, it makes the regulation of the flyback DC-DC converter slow and hard to fast response line and load change.

In the forward converter, due to reset requirement for the switching transformer, in general, it makes the primary switch's duty-cycle of the switching transformer less than 50% to avoid the switching transformer saturation. It is reset requirement that makes the primary switch's voltage stress of the switching transformer is double the input voltage in general. For higher input voltage application, the selection for the primary side switch is hard to meet both high performance and low cost. In the forward DC-DC converter, the current stress for all components is determined with the output current. If the voltage stress on components can be decreased, the DC-DC converter can be high performance and low cost.

### SUMMARY OF THE INVENTION

Invention is based on the forward DC-DC converter to decrease components' voltage stress and keep the low current stress as well as to extend the duty-cycle regulation range to 100%. With the invention, the DC-DC converter can be in high performance and low cost.

According to the present invention, a combination power topology is disclosed and includes a step down current regulator, two modified out of phase forward DC-DC converters.

The present invented isolated current regulated DC-DC converter is composed of the step down switch SA, free wheel diode DA, step down inductor L, switches S1 and S2, capacitor Cc to absorb the leakage energy of the switching transformer, output diodes D3 and D4, output filter capacitor C and the switching transformer T; one terminal of the step down inductor L is connected with the step down switch SA and free wheel diode DA, and other terminal of the step down inductor L is connected with one of primary windings of the switching transformer and switch S1 or S2; two primary windings of the switching transformer are respectively connected with switches S1 and S2 in series; two primary winding and switch S1 or S2 branches are paralleled and respectively connected with the free wheel diode DA and the step down inductor L; the free wheel diode DA is series with the step down switch SA and they connect with the input voltage Vin; the capacitor Cc to absorb the leakage energy of the switching transformer is respectively connected with switches S1 and S2; the full wave rectifier is composed of two secondary windings and output diodes D3, D4; the output capacitor C is paralleled with the output load.

In the converter, switches S1 and S2 turn on or off alternatively, that is, S1 is on and S2 is off and vice verse; in this way, the current of the step down inductor can pass two primary windings of the switching transformer in out of phase and output to the load in a fixed ratio through two secondary windings and output diodes D3, D4.

In the converter, the duty-cycle ratio of the step down switch SA can be from 0% to 100%.

In the converter, switches S1 and S2 can be self oscillating driven or external driven.

In the converter, the voltage stress on S1, S2, D3 and D4 is independent of the input voltage and dependent on the output voltage and the turns-ratio of the switching transformer.

In the converter, the voltage stress on the step down switch SA and the free wheel diode DA is the input voltage Vin.

In the converter, the current stress in SA, DA, S1, S2, is dependent on the output current and the turns ratio of the switching transformer.

In the converter, output diodes D3 and D4 can be replaced with synchronized rectifiers MOSFET S3 and S4 for high current application.

According to an advantage of the instant invention, the voltage stress on two switches in two modified out of phase forward DC-DC converters is independent of the input voltage Vin, and voltage stress on two switches and output diodes is dependent on the output voltage and the turns-ratio of the switching transformer. According to an advantage of the instant invention, the current stress of two switches in two modified out of phase forward DC-DC converters can be adjusted with the turns-ratio of the switching transformer and the output load current.

According to an advantage of the instant invention, two switching transformers in two modified out of phase forward DC-DC converters can be replaced with one switching transformer. According to an advantage of the instant invention, the switching transformer can operate in both the first and third quadrants with no DC bias. It is different with one in the forward DC-DC converter. In the forward DC-DC converter, the switching transformer only operates in the first quadrant and has DC bias. The size of the switching transformer can be half of one for regular forward DC-DC converter. According to an advantage of the instant invention, the leakage energy in the switching transformer can be lossless fed to the output load and it makes the invented converter to operate in high efficiency and high switching frequency.

According to an advantage of the instant invention, two switches in two modified out of phase forward DC-DC converters can be turned on in zero voltage switching (ZVS) condition and the switching loss on two switches can be much low. According to an advantage of the instant invention, two switches can operate in 50% duty-cycle with out of phase. According to an advantage of the instant invention, two switches can be droved in low cost self oscillation.

According to an advantage of the instant invention, the switch in step down current regulator can turn on and off in wide duty-cycle ratio from 0% to 100%. According to an advantage of the instant invention, the dynamic regulation performance of the invented isolated high performance-cost ratio current regulated DC-DC converter is much closed to one of the regular step down DC-DC converter. Due to the switching transformer in the invented isolated high performance-cost ratio current regulated DC-DC converter, the step down switch SA can be droved in common ground.

### BRIEF DESCRIPTION OF THE DRAWINGS

FIG. 1 illustrates a conventional forward DC-DC converter.

FIG. 2 illustrates a combination of two modified out of phase forward DC-DC converters.

FIG. 3 illustrates the combination of FIG. 2 and step down DC-DC current regulation function structure as the proposal invention

FIG. 4 illustrates an electrical circuit diagram of isolated current regulated DC-DC converter according to preferred embodiment of the instant invention

FIG. 5 illustrates an electrical circuit diagram of a second preferred embodiment of the present invention, showing BJT as switches S1 and S2 with anti-parallel diodes

FIG. 6 illustrates an electrical circuit diagram of a third preferred embodiment of the present invention, showing BJT as switches S1 and S2

FIG. 7 illustrates an electrical circuit diagram of a fourth preferred embodiment of the present invention, showing the step down switch SA is in common ground driving and MOSFET as switches S1 and S2

FIG. 8 illustrates an electrical circuit diagram of a fifth preferred embodiment of the present invention, showing the step down switch SA is in common ground driving and BJT as switches S1 and S2 with anti-parallel diodes

FIG. 9 illustrates an electrical circuit diagram of a sixth preferred embodiment of the present invention, showing the step down switch SA is in common ground driving and BJT as switches S1 and S2

FIG. 10 illustrates an electrical circuit diagram of a seventh preferred embodiment of the present invention, showing FIG. 4 with synchronized rectifiers S3 and S4

FIG. 11 illustrates an electrical circuit diagram of an eighth preferred embodiment of the present invention, showing FIG. 5 with synchronized rectifiers S3 and S4

FIG. 12 illustrates an electrical circuit diagram of a ninth preferred embodiment of the present invention, showing FIG. 6 with synchronized rectifiers S3 and S4

FIG. 13 illustrates an electrical circuit diagram of a tenth preferred embodiment of the present invention, showing FIG. 7 with synchronized rectifiers S3 and S4

FIG. 14 illustrates an electrical circuit diagram of an eleventh preferred embodiment of the present invention, showing FIG. 8 with synchronized rectifiers S3 and S4

FIG. 15 illustrates an electrical circuit diagram of a twelfth preferred embodiment of the present invention, showing FIG. 9 with synchronized rectifiers S3 and S4

### DETAILED DESCRIPTION OF THE INVENTION

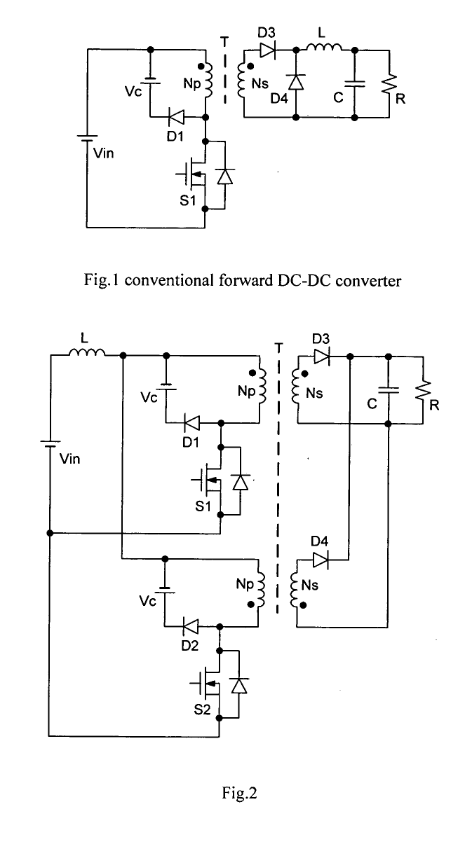

The conventional forward DC-DC converter is shown in FIG. 1. Vc is a clamping voltage. In general, Vc=Vin. The primary switch's voltage stress is twice of the input voltage. The components' current stress is Ns*Io/Np, Io is the output current.

In FIG. 1, if the inductor L is moved from the secondary to the primary, in order to keep the inductor current continuous, an additional auxiliary forward converter is added and shown in FIG. 2. As shown in FIG. 2, switches S1 and S2 turns on alternately, that is, as S1 turns on, S2 turns off, vice verse. The clamping voltage Vc=Np*Vo/Ns and Vo is the output voltage.

Due to S1 and S2 turn on and off alternately, the inductor L current can be transferred through S1, S2, D3, D4 and the switching transformer T to the load. In this case, S1 and S2's voltage stress is 2×Vc=2×Np*Vo/Ns. It is obvious that as long as the inductor L current can be controlled, the output current and voltage of the DC-DC converter can be controlled. Because the current in the primary windings of the transformer is the inductor L current, as long as the inductor current can be controlled, there is no saturation issue for the switching transformer.

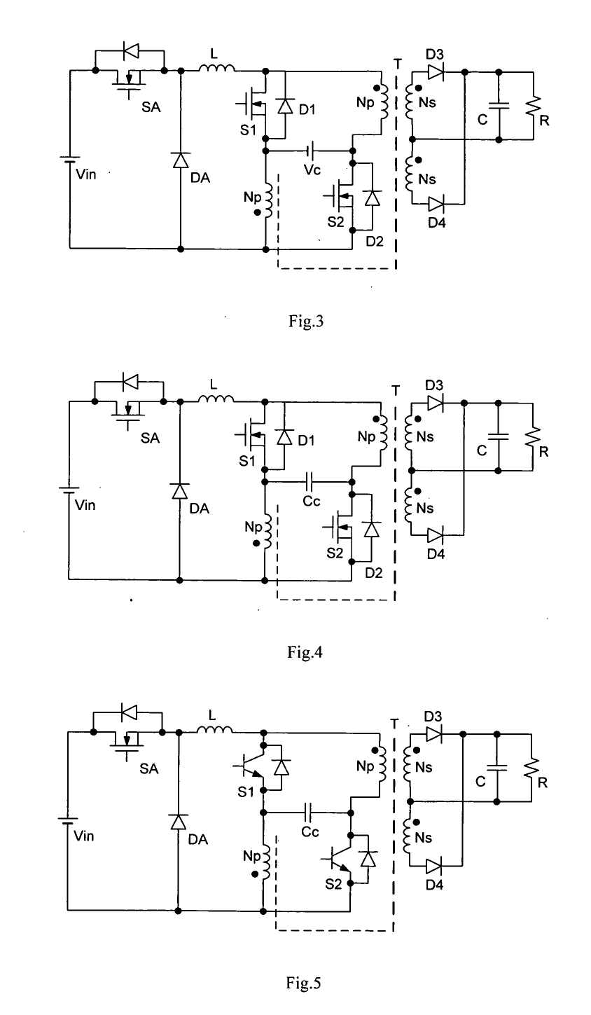

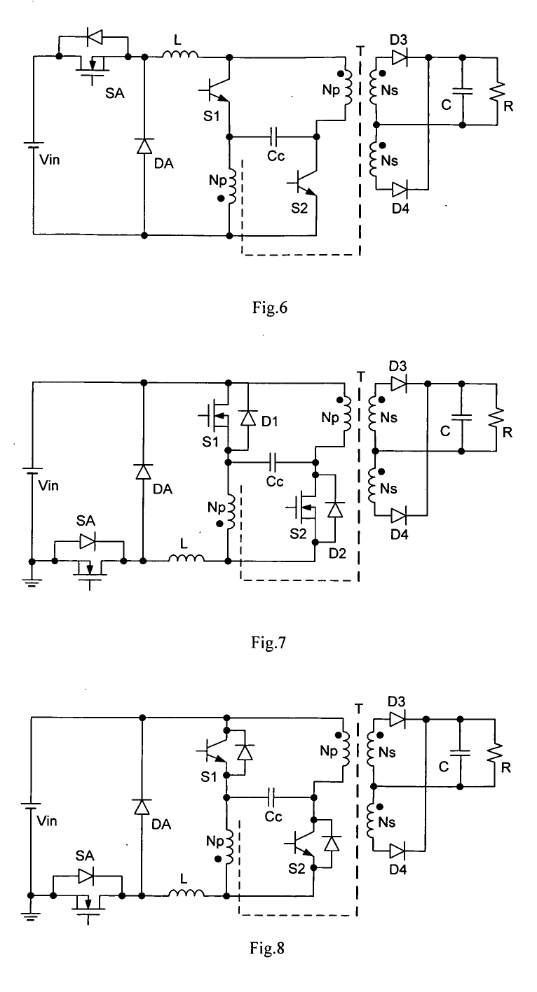

In order to control the inductor current, the easy way is to include a step down DC-DC current regulation function structure. FIG. 3 shows the combination of FIG. 2 and step down DC-DC current regulation function structure as the proposal invention.

In FIG. 3, due to the inductor L current regulation, the circuit operation condition is switches S1 and S2 must be turned on and off alternately. As shown in the circuit, as long as the inductor L current can be instant continuous as S1 or S2 turns off, it can avoid the high voltage spark on switches S1 and S2. It is switches S1 and S2 turn on and off alternately that makes the inductor L current to be instant continuous. Of cause, if switches S1 and S2 can't be instantly turned on and off alternately, it is a way to decrease the voltage spark to connect a capacitor or capacitor plus resistor with the inductor L and the free wheel diode DA, but it will generate an additional loss in the circuit.

In the circuit, the switching frequency of the step down switch SA can be independent of one for S1 and S2. SA's switching frequency is determined with the step down inductor L and the output filter capacitor C, that is, impact on the inductor L current ripple and the output voltage ripple. The switching frequency for S1 and S2 is determined with the switching transformer, that is, impact on the switching transformer's voltage-second.

The voltage stress of SA is the input voltage Vin. The voltage stress of S1 and S2 is 2×Np*Vo/Ns. SA, S1 and S2's current stress are Ns*Io/Np. Based on the expression of S1 and S2 voltage stress, it is possible to limit the voltage stress under a reasonable voltage with a suitable switching transformer turns ratio.

Switches S1 and S2 are used to transfer the inductor L current to the load through the switching transformer. It is current driving the switching transformer, the duty-cycle of S1 and S2 can be any D and (1−D). Of cause, in order to thermal balance for S1, S2, D3, D4 and magnetic balance for the switching transformer, duty-cycle D is generally selected around 0.5. It is D=0.5 that is possible to use low cost self-oscillation driving scheme to drive S1 and S2. The required or allowed size of the switching transformer determines the switching frequency of switches S1 and S2.

As shown in FIG. 3, the switching transformer's leakage energy absorbed by Vc clamping voltage source. The leakage energy can be transferred to the load in the secondary of the switching transformer through S1 and S2 turn-on and off alternately. The clamping voltage source Vc can be replaced with a capacitor Cc as shown in FIG. 4.

As shown in FIG. 4, when S1 or S2 turns off, due to the leakage inductor effect of the switching transformer, it makes S2 or S1's body diode turns on and S2 or S1 can be turned on in Zero Voltage Switching (ZVS) condition. Because the leakage energy of the switching transformer can be fed to the load in lossless, it makes the DC-DC current transformer composed of S1, S2, Cc, D3, D4 and the switching transformer T operate in high efficiency and high switching frequency.

In the invented isolated high performance-cost ratio current regulated DC-DC converter, there is no stored energy in the DC-DC current transformer composed of S1, S2, Cc, D3, D4 and the switching transformer T. The energy stored components in the invented isolated high performance-cost ratio current regulated DC-DC converter are the inductor L and the output filter capacitor C. It is the same as one in the regular step down DC-DC converter. The dynamic regulation performance of the invented isolated high performance-cost ratio current regulated DC-DC converter is much closed to one of the regular step down DC-DC converter. Because SA's duty-cycle can be 0% to 100%, the dynamic regulation range of the invented isolated high performance-cost ratio current regulated DC-DC converter is much larger than one of conventional forward DC-DC converter.

Besides the dynamic regulation performance of the invented isolated high performance-cost ratio current regulated DC-DC converter is much closed one that the regular step down DC-DC converter has, it also has the required function to isolate the DC-DC converter's input and output with the switching transformer. In practical application, due to the freedom of the switching transformer's turns-ratio, it is possible to make the invented isolated high performance-cost ratio current regulated DC-DC converter to operate in much better condition than one for the regular step down DC-DC converter and to have higher efficiency. Due to self oscillation driving for S1 and S2, it can be in low cost to implement the DC-DC current transformer composed of S1, S2, Cc, D3, D4 and the switching transformer T.

Due to S1 and S2 turn-on and off alternately, the switching transformer can operate in the first and third quadrants and there is no DC bias. It is different with the forward DC-DC converter. In the forward DC-DC converter, the switching transformer only operates in the first quadrant and has DC bias. It makes the size of the switching transformer for the invented isolated high performance-cost ratio current regulated DC-DC converter half one of the switching transformer for the regular forward DC-DC converter.

To compare with the regular forward DC-DC converter, the invented isolated high performance-cost ratio current regulated DC-DC converter has no additional energy stored component except the Cc to absorb the leakage energy of the switching transformer.

Low cost power BJT can be used as S1 and S2. Higher performance-cost ratio isolated current regulated DC-DC converters are shown in FIG. 5, 6.

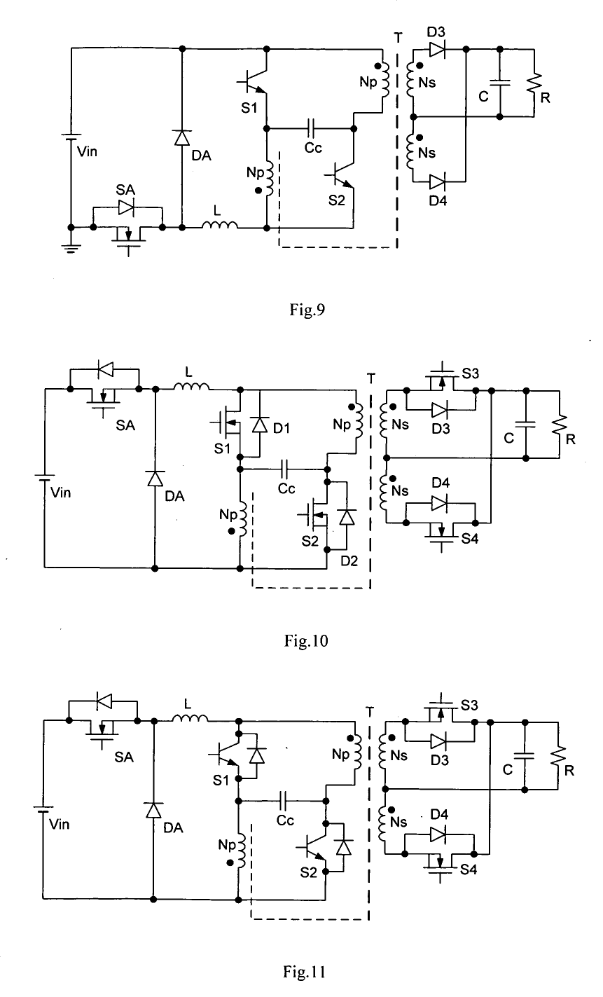

In the invented isolated high performance-cost ratio current regulated DC-DC converter, due to the switching transformer, the step down switch SA can be droved in common ground as shown in FIGS. 7, 8 and 9.

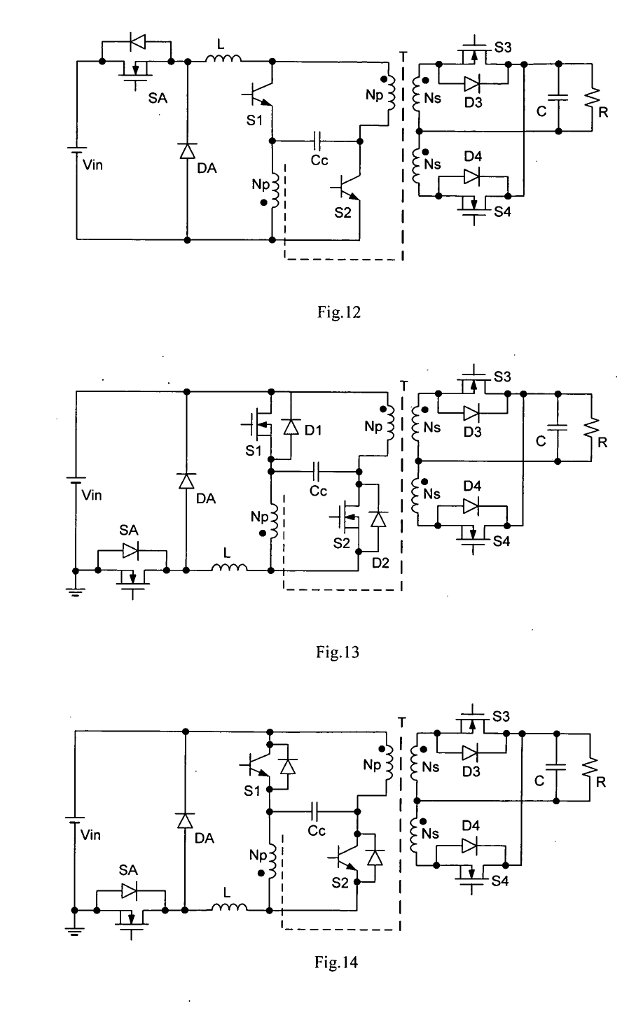

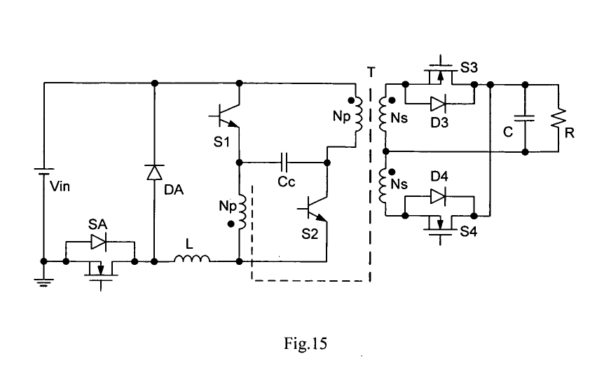

Output diodes D3 and D4 can be replaced with synchronized rectifiers MOSFET S3 and S4 for high current application. Due to 50% turn-on duty-cycle for D3 and D4, it is very easy to self drive S3 and S4 in low cost as shown in FIGS. 10, 11, 12, 13, 14 and 15.

What is claimed is:

1. the isolated current regulated DC-DC converter is composed of the step down switch SA, free wheel diode DA, step down inductor L, switches S1 and S2, capacitor Cc to absorb the leakage energy of the switching transformer, output diodes D3 and D4, output filter capacitor C and the switching transformer T; one terminal of the step down inductor L is connected with the step down switch SA and free wheel diode DA, and other terminal of the step down inductor L is connected with one of primary windings of the switching transformer and switch S1 or S2; two primary windings of the switching transformer are respectively connected with switches S1 and S2 in series; two primary winding and switch S1 or S2 branches are paralleled and respectively connected with the free wheel diode DA and the step down inductor L; the free wheel diode DA is series with the step down switch SA and they connect with the input voltage Vin; the capacitor Cc to absorb the leakage energy of the switching transformer is respectively connected with switches S1 and S2; the full wave rectifier is composed of two secondary windings and output diodes D3, D4; the output capacitor C is paralleled with the output load.

2. the isolated current regulated DC-DC converter of claim 1, wherein switches S1 and S2 turn on or off alternatively, that is, S1 is on and S2 is off and vice verse; in this way, the current of the step down inductor can pass two primary windings of the switching transformer in out of phase and output to the load in a fixed ratio through two secondary windings and output diodes D3, D4.

3. The isolated current regulated DC-DC converter of claim 1, wherein the duty-cycle ratio of the step down switch SA can be from 0% to 100%.

4. The isolated current regulated DC-DC converter of claim 1, wherein switches S1 and S2 can be self oscillating droved or external droved.

5. the isolated current regulated DC-DC converter of claim 1, wherein the voltage stress on S1, S2, D3 and D4 is independent of the input voltage and dependent on the output voltage and the turns ratio of the switching transformer.

6. The isolated current regulated DC-DC converter of claim 1, wherein the voltage stress on the step down switch SA and the free wheel diode DA is the input voltage Vin.

7. the isolated current regulated DC-DC converter of claim 1, wherein the current stress in S1, S2, is dependent on the output current and the turns ratio of the switching transformer.

8. The isolated current regulated DC-DC converter of claim 1, wherein output diodes D3 and D4 can be replaced with synchronized rectifiers MOSFET S3 and S4 for high current application.
